(19) United States
(12) Patent Application Publication
(10) Pub. No.: US 2020/0262369 A1
(43) Pub. Date: Aug. 20, 2020

(54) POWER SUPPLY CONTROL DEVICE, VEHICLE INCLUDING THE POWER SUPPLY CONTROL DEVICE, POWER SUPPLY CONTROL METHOD, AND POWER SUPPLY CONTROL PROGRAM

(71) Applicant: MITSUBISHI HEAVY INDUSTRIES MACHINERY SYSTEMS, LTD., Hyogo (JP)

(72) Inventors: Naruhisa KAMEO, Tokyo (JP); Hiromichi NAKAMOTO, Tokyo (JP); Hiroyuki NAKAYAMA, Tokyo (JP)

(21) Appl. No.: 16/758,426

(22) PCT Filed: Oct. 31, 2017
(86) PCT No.: PCT/JP2017/039340

§ 371 Date: Apr. 23, 2020

(51) Int. Cl. B60R 16/033

(52) U.S. Cl. CPC B60R 16/033

(57) ABSTRACT

A power supply control device for controlling power supply to an onboard device mounted in a vehicle includes a boarding detection signal receiver configured to receive a detection signal from a boarding detection unit configured to detect boarding of the vehicle by a user before an engine of the vehicle is started, and a power supply control unit configured to supply power from a battery mounted in the vehicle to the onboard device upon receiving the detection signal.

### TECHNICAL FIELD

The present invention relates to a power supply control device, a vehicle including the power supply control device, a power supply control method, and a power supply control program.

### BACKGROUND ART

After the engine of a vehicle is started, onboard devices which are electronic devices mounted in the vehicle such as an onboard navigation device (a so-called “car navigation unit”) and a car audio are powered on and the onboard devices start their systems to provide services. Therefore, even when a driver or the like has boarded a parked vehicle or the like and started the engine, he or she cannot immediately receive services provided by onboard devices such as route guidance of a car navigation unit and music playing of a car audio. One solution to this problem is a technique of causing an onboard device to wait in a sleep state rather than completely powering off the onboard device. However, parking for a long time in this method exhausts a battery that supplies power to the onboard device.

Another known solution to the above problem is a technique of speeding up the startup of the onboard device itself. For example, Patent Literature 1 describes a hibernation technique as an example of the technique of speeding up the startup of an information processing device itself. In this hibernation technique, the content of a main memory in a running state of the information processing device is stored in a nonvolatile storage device as a snapshot image, and the stored snapshot image is decompressed and loaded when the information processing device is started, such that processing such as initialization required in a normal startup procedure can be omitted and fast startup can be performed. Thus, use of the technique of speeding up the startup of the onboard device itself can reduce the time from when the driver or the like boards the vehicle and starts the engine to when he or she receives a service provided from the onboard device.

### CITATION LIST

### Patent Literature

### [Patent Literature 1]

Japanese Unexamined Patent Application, First Publication No. 2017-156205

### SUMMARY OF INVENTION

### Technical Problem

When the technique of speeding up the startup of the onboard device itself is used, the startup time of the onboard device is reduced, but a certain processing time is still required and the waiting time from when the driver or the like boards the vehicle in which the engine has been stopped to when the onboard device provides a service is not negligible. Thus, there is a need for a technique of effectively reducing the waiting time from when the engine is started in the vehicle in which the engine has been stopped to when the onboard device provides a service.

In view of the above problems, the present invention provides a power supply control device, a vehicle including the power supply control device, a power supply control method, and a power supply control program which can effectively reduce a waiting time from when an engine is started in a vehicle in which the engine has been stopped to when an onboard device provides a service.

### Solution to Problem

According to a first aspect of the present invention, a power supply control device (10) for controlling power supply to an onboard device (5) mounted in a vehicle (1) includes a boarding detection signal receiver (11) configured to receive a detection signal from a boarding detection unit (3) configured to detect boarding of the vehicle by a user before an engine of the vehicle is started, and a power supply control unit (12) configured to supply power from a battery (2) mounted in the vehicle to the onboard device upon receiving the detection signal.

Rather than supplying power to a car navigation unit or the like which is the onboard device of the vehicle after the user starts the engine of the vehicle, boarding of the vehicle by the user is detected in advance by a boarding detection unit such as a human detection sensor before the engine of the vehicle is started and, with this detection as a trigger, the power supply control unit supplies power from the battery to the onboard device as described above. Therefore, it is possible to effectively reduce a waiting time from when the user boards the vehicle and starts the engine to when the onboard device provides a service.

According to a second aspect of the present invention, the onboard device (5) is configured to be started when power has been supplied from the battery (2) mounted in the vehicle (1) to the onboard device and is configured not to provide a service to the user until the engine of the vehicle is started if it becomes possible to provide a service to the user before the engine of the vehicle is started.

Because the onboard device does not provide a service to the user after being started until the engine of the vehicle is started as described above, it is possible to limit consumption of the battery which is mounted in the vehicle and supplies power to the onboard device 5. Thus, it is possible to reduce the waiting time from when the user boards the vehicle to when the onboard device provides a service without lowering energy efficiency.

According to a third aspect of the present invention, the power supply control device further includes a timer unit (13) configured to measure an elapsed time since power was supplied to the onboard device (5) until the engine of the vehicle (1) is started, wherein the power supply control unit (12) is configured to cut off power supply from the battery (2) mounted in the vehicle to the onboard device if the engine of the vehicle is not started within a predetermined determination time after power was supplied to the onboard device.

An elapsed time since power was supplied to the onboard device is measured until the engine of the vehicle is started using the timer unit, and thus the power supply control unit can cut off power supply from the battery mounted in the vehicle to the onboard device if the engine of the vehicle is not started within a predetermined determination time after power was supplied to the onboard device as described above. Thereby, it is possible to prevent a situation in which the power supply control device continues to supply power to the onboard device even though the vehicle is not immediately used for driving due to erroneous detection of the boarding detection unit or the like, and thus to limit waste of the battery of the vehicle.

According to a fourth aspect of the present invention, a vehicle (1) includes the power supply control device (10) according to any one of the first to third aspects, the battery (2), the onboard device (5), and the boarding detection unit (3).

According to a fifth aspect of the present invention, a power supply control method for controlling power supply to an onboard device mounted in a vehicle includes a boarding detection signal receiving step of receiving a detection signal from a boarding detection unit configured to detect boarding of the vehicle by a user before an engine of the vehicle is started, and a power supply control step of supplying power from a battery mounted in the vehicle to the onboard device upon receiving the detection signal.

According to a sixth aspect of the present invention, a power supply control program causes a computer (9) serving as a power supply control device for controlling power supply to an onboard device mounted in a vehicle to function as a boarding detection signal receiver configured to receive a detection signal from a boarding detection unit configured to detect boarding of the vehicle by a user before an engine of the vehicle is started, and a power supply control unit configured to supply power from a battery mounted in the vehicle to the onboard device upon receiving the detection signal.

### Advantageous Effects of Invention

According to the power supply control device, the vehicle including the power supply control device, the power supply control method, and the power supply control program described above, it is possible to effectively reduce the waiting time from when the user boards the vehicle in which the engine has been stopped and starts the engine to when the onboard device provides a service.

### BRIEF DESCRIPTION OF DRAWINGS

FIG. 1 is a schematic diagram showing an overall configuration of a vehicle including a power supply control device according to a first embodiment.

FIG. 2 is a block diagram illustrating a configuration of a power supply control device according to the first embodiment.

FIG. 3 is a flowchart showing an operation of the power supply control device according to the first embodiment.

FIG. 4 is an explanatory diagram illustrating a startup procedure of an onboard device according to the first embodiment in comparison with startup procedures of the related art.

FIG. 5 is an explanatory diagram illustrating a startup procedure of an onboard device according to a first modification of the first embodiment.

FIG. 6 is a block diagram illustrating a configuration of a power supply control device according to a second embodiment.

FIG. 7 is a flowchart showing an operation of the power supply control device according to the second embodiment.

FIG. 8 is a schematic block diagram showing a configuration of a computer according to at least one embodiment.

### DESCRIPTION OF EMBODIMENTS

### First Embodiment

Hereinafter, a first embodiment of the present invention will be described with reference to the drawings. In all drawings, the same or corresponding components are given the same reference signs and common descriptions are not repeated.

### (Overall Configuration of Vehicle Including Power Supply Control Device According to First Embodiment)

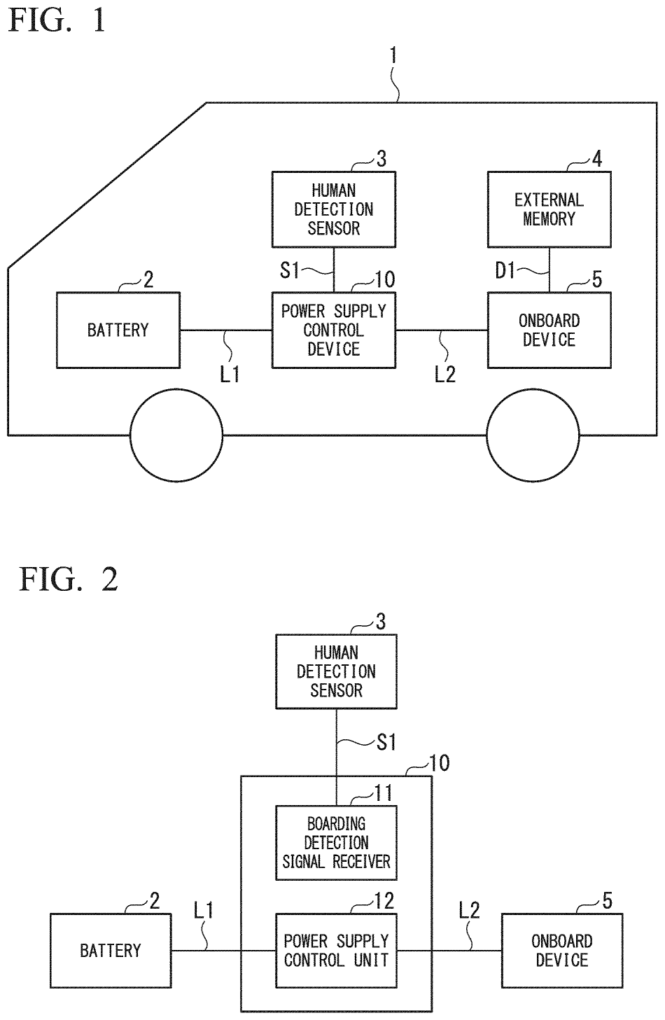

FIG. 1 is a schematic diagram showing an overall configuration of a vehicle 1 including a power supply control device 10 according to the first embodiment of the present invention. The overall configuration of the vehicle 1 including the power supply control device 10 according to the first embodiment of the present invention will be described with reference to FIG. 1.

As shown in FIG. 1, the vehicle 1 includes a battery 2, a human detection sensor 3, a power supply control device 10, an external memory 4, and an onboard device 5. The first embodiment of the present invention will be described with reference to the case where the vehicle 1 is a gasoline vehicle. However, the vehicle 1 may be, for example, a vehicle which uses a drive power source other than gasoline, such as a diesel vehicle, a hydrogen vehicle, a fuel cell vehicle, or a hybrid vehicle.

The battery 2 is a DC power source that is mounted in the vehicle 1 and supplies power to each load in the vehicle 1 and is configured to be charged as the vehicle 1 travels. The battery 2 is connected to the power supply control device 10 via a power supply line L1 and is configured to supply power to the onboard device 5 via the power supply control device 10. FIG. 1 shows only a configuration in which the battery 2 supplies power to the onboard device 5 via the power supply control device 10 for ease of description. However, the battery 2 may supply power to other devices such as the human detection sensor 3, the power supply control device 10, the external memory 4, and the onboard device 5.

The human detection sensor 3 is a boarding detection unit for detecting boarding of the vehicle 1 by a user. In the first embodiment of the present invention, the human detection sensor 3 is a temperature sensor and is configured to detect boarding of the vehicle 1 by the user, for example, by detecting infrared rays emitted from the user who has boarded (entered) the vehicle 1 using a pyroelectric effect. The human detection sensor 3 is connected to the power supply control device 10 via a signal line Si. Upon detecting infrared rays emitted from the user who has boarded the vehicle 1, the human detection sensor 3 outputs a detection signal indicating that boarding of the vehicle 1 by the user has been detected to the power supply control device 10 via the signal line Si.

Here, the human detection sensor 3 that detects that the user has boarded (entered) the vehicle 1 may be a contact-type temperature sensor or a non-contact-type temperature sensor. The human detection sensor 3 may also be a sensor other than a temperature sensor, such as an optical sensor or a pressure sensor. In an example, the optical sensor may be a sensor that detects reflected light of emitted light, reflected by the user who has boarded the vehicle 1. In another example, the pressure sensor may be a pressure sensor or the like that detects a pressure of a user who has boarded the vehicle 1 sitting on a seat.

The human detection sensor 3 according to the first embodiment has been described as detecting that the user has actually boarded (entered) the vehicle 1, but is not limited to this mode in other embodiments. That is, the human detection sensor 3 according to another embodiment may be a sensor that detects boarding of the vehicle 1 by the user by detecting that the user has unlocked a door of the vehicle 1, that the user has approached a door of the vehicle 1 from outside the vehicle, or the like. In the case of the mode of detecting unlocking of the door of the vehicle 1, the human detection sensor 3 may be a sensor that monitors a signal indicating the state of a door lock mechanism installed on the door of the vehicle 1 (indicating whether or not the door is locked). In the case of the mode of detecting that the user has approached a door of the vehicle 1 from outside the vehicle, the human detection sensor 3 may be not only the temperature sensor or the optical sensor described above but also, for example, a sensor that detects the strength of radio waves transmitted from a key for smart entry carried by the user.

The human detection sensor 3 may also be a combination of a plurality of types of sensors for detecting boarding of the vehicle 1 by the user.

Further, the phrase “detecting boarding of the vehicle 1 by the user” is not limited to detecting that the user has actually boarded (entered) the vehicle 1 and includes detecting various events that occur before the user actually boards the vehicle 1 (such as unlocking of the door of the vehicle 1 and the user approaching the door of the vehicle 1) as described above.

The onboard device 5 may be, for example, a car navigation unit that is provided in the vehicle 1 and is able to provide a user with a service such as route guidance to a destination. As shown in FIG. 1, the onboard device 5 is connected to the power supply control device 10 via a power supply line L2 and is configured such that power is supplied to the onboard device 5 from the battery 2 via the power supply control device 10. The first embodiment of the present invention will be described with reference to the case where the onboard device 5 is a car navigation unit. However, the onboard device 5 may be, for example, another device such as a car audio or onboard unit which is provided in the vehicle 1 and supplied power by the battery 2, and is able to provide a service to the user. The car navigation unit, which is the onboard device 5, is configured to be started when the battery 2 supplies power thereto via the power supply control device 10.

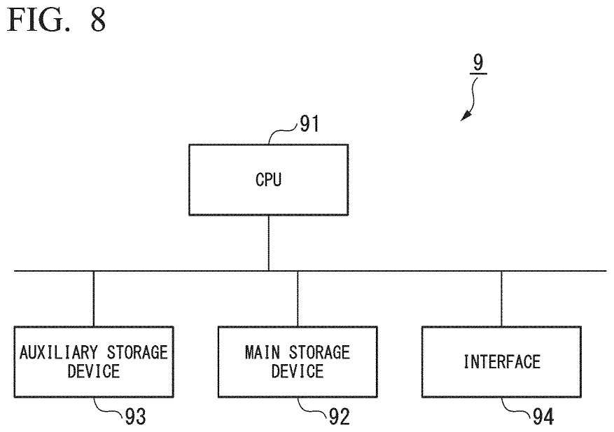

The onboard device 5 is connected to the external memory 4 which is a nonvolatile memory via a data line D1 as shown in FIG. 1. The onboard device 5 is configured such that only the content of an area being used in a main memory (a main storage device 92 shown in FIG. 8 which will be described later) among the content of the main memory in running states of the system and applications can be compressed and stored in the external memory 4 as a snapshot image. Here, storage in the main memory may be performed such that CPU register values in running states of the system and applications are also stored in the main memory as the snapshot image. In the first embodiment of the present invention, the content of the main memory in a state where the onboard device 5 is able to provide a service may be stored in the external memory 4 as a snapshot image. Thereby, the snapshot image compressed and stored in the external memory 4 can be decompressed and loaded into a memory (not shown) in the onboard device 5 via the data line D1 when the onboard device 5 is started as will be described later, such that it is possible to perform fast startup of the onboard device 5 which is known as hibernation startup.

The external memory 4 used for fast startup may be, for example, an auxiliary storage device such as a hard disk drive (HDD), a solid state drive (SSD), a magnetic disk, a magneto-optical disc, a compact disc read only memory (CD-ROM), a digital versatile disc read only memory (DVD-ROM), or a semiconductor memory.

### (Functional Configuration of Power Supply Control Device According to First Embodiment)

FIG. 2 is a block diagram illustrating a functional configuration of the power supply control device 10 according to a first embodiment. As shown in FIG. 2, the power supply control device 10 includes a boarding detection signal receiver 11 that receives a detection signal from the human detection sensor 3, which is a boarding detection unit that detects boarding of the vehicle 1 by the user, before the engine (not shown) of the vehicle 1 is started and a power supply control unit 12 that supplies power from a battery 2 mounted in the vehicle 1 to the onboard device 5 upon receiving the detection signal.

The boarding detection signal receiver 11 is configured to, upon receiving a detection signal indicating that boarding of the vehicle 1 by the user has been detected from the human detection sensor 3 which is a boarding detection unit via the signal line Si before the engine of the vehicle 1 is started, notify the power supply control unit 12 that the detection signal has been received. The boarding detection signal receiver 11 may determine that the engine of the vehicle 1 has not been started when an ignition signal indicating that the engine has been started is not input thereto from an ignition circuit (not shown).

Upon receiving the notification that the detection signal has been received from the boarding detection signal receiver 11, the power supply control unit 12 supplies power from the battery 2 mounted in the vehicle 1 to the car navigation unit which is the onboard device 5. Specifically, for example, the power supply control unit 12 connects the power supply line L1 connected between the battery 2 and the power supply control unit 12 in the power supply control device 10 to the power supply line L2 connected between the power supply control unit 12 and the onboard device 5 to supply power to the car navigation unit which is the onboard device 5.

### (Processing Flow of Operation of Power Supply Control Device According to First Embodiment)

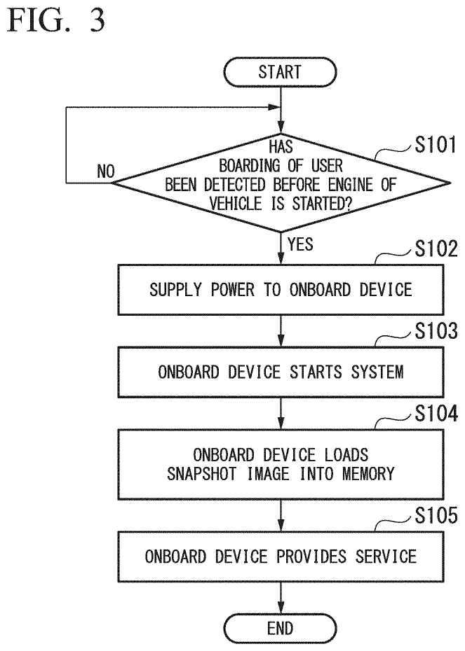

FIG. 3 is a flowchart showing an operation of the power supply control device 10 according to the first embodiment. The operation of the power supply control device 10 according to the first embodiment will be described with reference to FIG. 3. In FIG. 3, processing of steps S101 and S102 is performed by the power supply control device 10 and processing of steps S103 to S105 is performed by the onboard device 5, but the series of processing is shown in a single flowchart for ease of understanding.

The process of the flowchart shown in FIG. 3 may be started, for example, when a predetermined time has elapsed after the user of the vehicle 1 stops the vehicle 1 in a parking lot or the like and stops the engine. That is, the process of the flowchart shown in FIG. 3 may be started in a situation where the user is away from the vehicle 1. When the process of the flowchart shown in FIG. 3 is started, the boarding detection signal receiver 11 in the power supply control device 10 determines whether or not boarding of the vehicle 1 by the user has been detected before the engine of the vehicle 1 is started (step S101). Specifically, for example, when the engine has not been started, the human detection sensor 3 which is a boarding detection unit for detecting boarding of the vehicle 1 by the user detects boarding of the vehicle 1 by the user and, when this detection signal has been input to the boarding detection signal receiver 11 via the signal line 51, the boarding detection signal receiver 11 determines that boarding of the vehicle 1 by the user has been detected before the engine of the vehicle 1 is started (YES in step S101) and notifies the power supply control unit 12 that the detection signal has been received. Note that the boarding detection signal receiver 11 may determine that the engine has not been started when an ignition signal indicating that the engine has been started is not input thereto from the ignition circuit (not shown).

On the other hand, when the detection signal from the human detection sensor 3 has not been input to the boarding detection signal receiver 11 in the power supply control device 10, the boarding detection signal receiver 11 determines that boarding of the vehicle 1 by the user has not been detected before the engine of the vehicle 1 is started (NO in step S101) and the process returns to step 101. In this way, the processing of step S101 is repeated until the boarding detection signal receiver 11 determines that boarding of the vehicle 1 by the user has been detected before the engine of the vehicle 1 is started.

Upon receiving the notification that the detection signal has been received from the boarding detection signal receiver 11, the power supply control unit 12 supplies power to the car navigation unit which is the onboard device 5 (step S102). Specifically, for example, the power supply control unit 12 connects the power supply line L1 connected between the battery 2 and the power supply control unit 12 in the power supply control device 10 to the power supply line L2 connected between the power supply control unit 12 and the onboard device 5 to supply power to the car navigation unit which is the onboard device 5.

When power has been supplied to the onboard device 5, the onboard device 5 starts the system (step S103). In the first embodiment of the present invention, startup of the system of the onboard device 5 may be, for example, sequential execution of the operations of starting a BIOS and starting of a boot loader. In the first embodiment, through the operation of the boot loader, a snapshot image including a kernel, some drivers, and applications is decompressed and loaded into the main memory, thereby performing fast startup. The above operations for starting the system are merely examples and changes can be made in embodiments, such as changing the order of the operations as needed.

Next, the onboard device 5 decompresses and loads a snapshot image of the content of the main memory in a running state of the onboard device 5, which was previously stored in the external memory 4, from the external memory 4 into the memory (not shown) in the onboard device 5 via the data line D1 (step S104). In the first embodiment of the present invention, the content of the main memory in a running state of the onboard device 5 is previously stored in the external memory as snapshot image data in a form of compressed data. Therefore, in decompression/loading of the snapshot image data into the memory in the onboard device 5, the snapshot image data is copied to the memory in the onboard device 5 and then decompressed, thus bringing the onboard device 5 into a running state.

Next, the onboard device 5 provides a service (step S105). In the first embodiment of the present invention, the onboard device 5 which is the car navigation unit provides the user of the vehicle 1 with a service such as route guidance to a destination. Then, the process of the flowchart shown in FIG. 3 ends.

### (Description of Startup Procedure of Onboard Device According to First Embodiment)

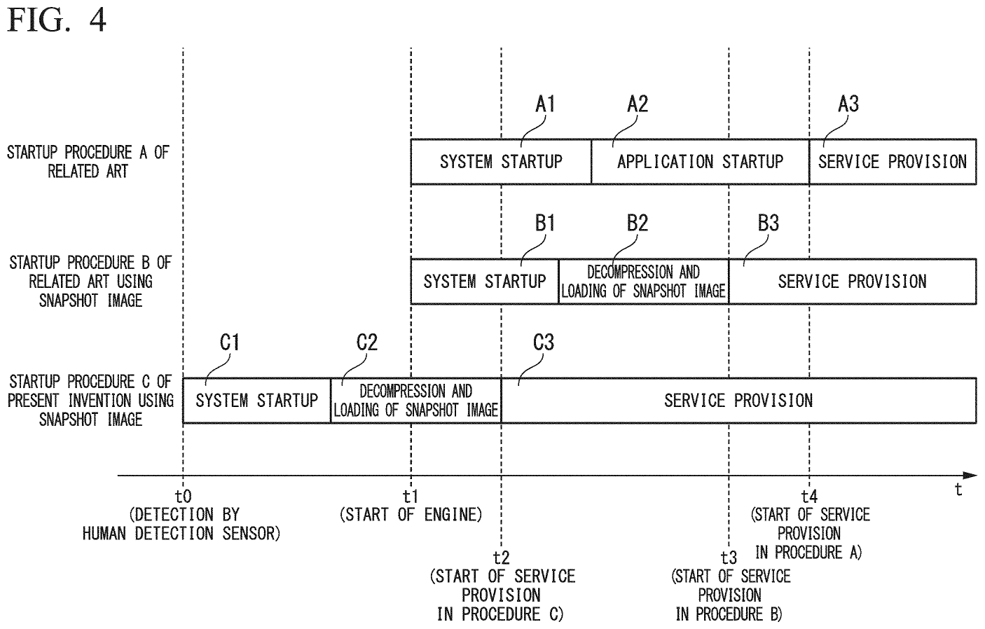

FIG. 4 is an explanatory diagram illustrating a startup procedure of the onboard device 5 according to the first embodiment in comparison with startup procedures of the related art. Differences between the startup procedure of the onboard device 5 according to the first embodiment and the startup procedures of the related art will be described with reference to FIG. 4.

FIG. 4 shows a relationship between each process when the onboard device 5 is started and a lapse of time. A startup procedure A of the related art, a startup procedure B of the related art using a snapshot image, and a startup procedure C of the present invention using a snapshot image are shown in order from the top in FIG. 4. The horizontal axis tin FIG. 4 is a time axis and the right side in FIG. 4 indicates a later time than the left side. On the time axis t, time t0 indicates the time when boarding of the vehicle 1 by the user is detected by the human detection sensor 3. Time t1 indicates the time when the engine of the vehicle 1 is started by the user. Times t2, t3, and t4 are the times when the onboard device 5 starts providing a service, that is, it becomes possible to provide a service, in the startup procedure C of the present invention, in the startup procedure B of the related art, and in the startup procedure A of the related art, respectively.

In the startup procedures A and B of the related art shown in FIG. 4, when the user starts the engine after boarding the vehicle 1, power is supplied to the onboard device 5 and the onboard device 5 is started. On the other hand, in the startup procedure of the present invention, with detection by the human detection sensor 3 of boarding of the vehicle 1 by the user as a trigger, the power supply control device 10 supplies power to the onboard device 5 and the onboard device 5 is started before the engine of the vehicle 1 is started as described above with reference to FIG. 3. The startup procedure B of the related art differs from the startup procedure A of the related art only in that it uses a snapshot image. Details are as follows.

In the startup procedure A of the related art, when the engine of the vehicle 1 is started at time t1, a system startup process A1 is started as shown in FIG. 4. In the case of the startup procedure A of the related art, startup of the system of the onboard device 5 may be sequential execution of the operations of starting the BIOS, starting the boot loader, starting a kernel, and starting drivers. In the startup procedure A of the related art, when the system startup process A1 is completed, an application startup process A2 is performed next. Specifically, an application required for the onboard device 5, which is the car navigation unit, to provide the user of the vehicle 1 with a service such as route guidance to a destination is started. When the application startup process A2 is completed at time t4, the onboard device 5 which is the car navigation unit starts a process A3 of providing the user of the vehicle 1 with a service such as route guidance to a destination.

In the startup procedure B of the related art, when the engine of the vehicle 1 is started at time t1, a system startup process B1 is started, similar to the startup procedure A of the related art, as shown in FIG. 4. In the case of the startup procedure B of the related art, the operations of starting the BIOS and starting the boot loader may be sequentially performed as the system startup process B1. Here, in the startup procedure B of the related art, after the system startup process B1 is completed, a process B2 of loading a snapshot image including a kernel, some drivers, and applications is performed for the purpose of fast startup rather than starting applications as in the startup procedure A of the related art. Specifically, a snapshot image including the content of the main memory in a running state of the onboard device 5, which was previously stored in the external memory or the like, is decompressed and loaded from the external memory into the memory of the onboard device 5. Therefore, the time t3 when the process B2 of decompressing and loading the snapshot image is completed and it becomes possible for the onboard device 5, which is the car navigation unit, to start providing a service such as route guidance is earlier than the time t4 in the startup procedure A of the related art as shown in FIG. 4. As shown in FIG. 4, a period of time required for the system startup process B1 of the onboard device 5 is shorter than a period of time required for the system startup process A1 in the startup procedure A of the related art because the system startup process B1 only needs to be a minimum process for enabling execution of the process B2 of decompressing and loading the snapshot image.

In the startup procedure C of the present invention, a system startup process C1 is started when boarding of the vehicle 1 by the user has been detected by the human detection sensor 3 unlike in the startup procedures A and B of the related art as shown in FIG. 4. In the startup procedure C of the present invention, the operations of starting the BIOS and starting the boot loader are sequentially performed as the system startup process C1. In the startup procedure C of the present invention, a process C2 of decompressing and loading a snapshot image including a kernel, some drivers, and applications is performed after the system startup process C1 is completed for the purpose of fast startup, similar to the startup procedure B of the related art. As shown in FIG. 4, the time t2 when the process C2 of decompressing and loading the snapshot image is completed and it becomes possible for the onboard device 5, which is the car navigation unit, to start providing a service such as route guidance is earlier than the time t4 in the startup procedure A of the related art and the time t3 in the startup procedure B of the related art as shown in FIG. 4.

### (Operations and Advantageous Effects)

As described above, the power supply control device 10 according to the first embodiment includes the boarding detection signal receiver 11 that receives a detection signal from the human detection sensor 3, which is a boarding detection unit that detects boarding of the vehicle 1 by the user, before the engine of the vehicle 1 is started and the power supply control unit 12 that supplies power from the battery 2 mounted in the vehicle 1 to the car navigation unit which is the onboard device 5 upon receiving the detection signal.

Thus, rather than supplying power to the car navigation unit which is the onboard device 5 of the vehicle 1 after the user starts the engine of the vehicle 1, boarding of the vehicle 1 by the user is detected in advance by the human detection sensor 3 before the engine of the vehicle 1 is started and, with this detection as a trigger, the power supply control unit 12 supplies power from the battery 2 to the onboard device 5. Therefore, it is possible to effectively reduce a waiting time from when the user boards the vehicle 1 and starts the engine to when the onboard device 5 provides a service.

In particular, when startup of the onboard device 5 has been completed before the engine of the vehicle 1 is started, the waiting time from when the user boards the vehicle 1 and starts the engine to when the onboard device 5 provides a service becomes zero. Thus, the user such as a driver can receive the service provided by the onboard device 5 very comfortably without having the stress of waiting until the service is provided.

### First Modification of First Embodiment

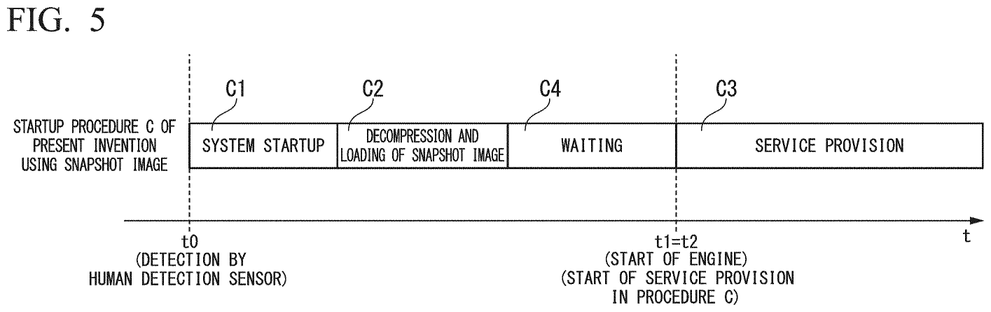

FIG. 5 is an explanatory diagram illustrating a startup procedure of the onboard device 5 according to a first modification of the first embodiment. The startup procedure of the onboard device 5 according to the first modification of the first embodiment will be described with reference to FIG. 5. The onboard device 5, a power supply control device 10, and a vehicle 1 according to the first modification of the first embodiment are configured and function similar to the onboard device 5, the power supply control device 10, and the vehicle 1 according to the first embodiment unless otherwise specified and thus a description other than that of the startup procedure of the onboard device 5 is omitted.

In a startup procedure C of the present invention shown in FIG. 5, processes C1 to C3 are each performed in substantially the same manner as in the startup procedure C of the present invention shown in FIG. 4, with the difference being that a process C4 of waiting until the time t1 when the engine of the vehicle 1 is started is performed after the process C2 of decompressing and loading the snapshot image is completed rather than performing a service providing process C3 immediately after the process C2 is completed. That is, the onboard device 5 is configured such that, when power is supplied from the battery 2 mounted in the vehicle 1 to the onboard device 5, the onboard device 5 sequentially performs startup of the system (process C1) and decompression and loading of the snapshot image (process C2), and if it becomes possible to provide a service to the user before the engine of the vehicle 1 is started, the onboard device 5 does not perform the process C3 of providing a service to the user until the engine of the vehicle 1 is started.

Thus, the time t2 when it becomes possible for the onboard device 5 which is the car navigation unit to start providing a service such as route guidance is the same as the time t1 when the engine of the vehicle 1 is started as shown in FIG. 5. If the onboard device 5 starts the system (performs the processes C1 and C2) and then it becomes possible for the onboard device 5 to start providing a service to the user after the engine of the vehicle 1 is started, the onboard device 5 may start providing a service to the user immediately without performing the waiting process C4. In this case, the time t2 when the onboard device 5 starts providing a service is later than the time t1 when the engine of the vehicle 1 is started.

### (Operations and Advantageous Effects)

As described above, the onboard device 5 according to the first modification of the first embodiment is started when power has been supplied from the battery 2 mounted in the vehicle 1 to the onboard device 5, and if it becomes possible to provide a service to the user before the engine of the vehicle 1 is started, the onboard device 5 does not provide a service to the user until the engine of the vehicle 1 is started.

Because the onboard device 5 does not provide a service to the user after being started until the engine of the vehicle 1 is started as described above, it is possible to prevent power from being consumed for providing a service even though the user has not boarded the vehicle and thus to limit power consumption of the battery 2 which is mounted in the vehicle 1 and supplies power to the onboard device 5. Thus, it is possible to reduce the waiting time until the onboard device 5 provides a service without lowering energy efficiency.

### Second Embodiment

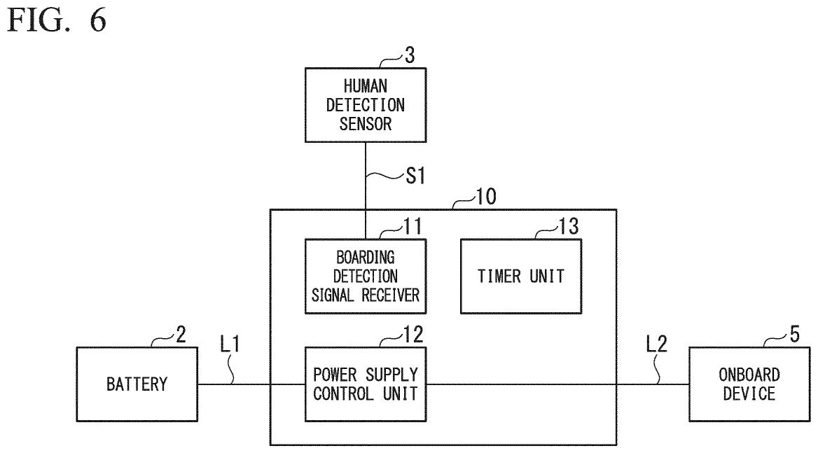

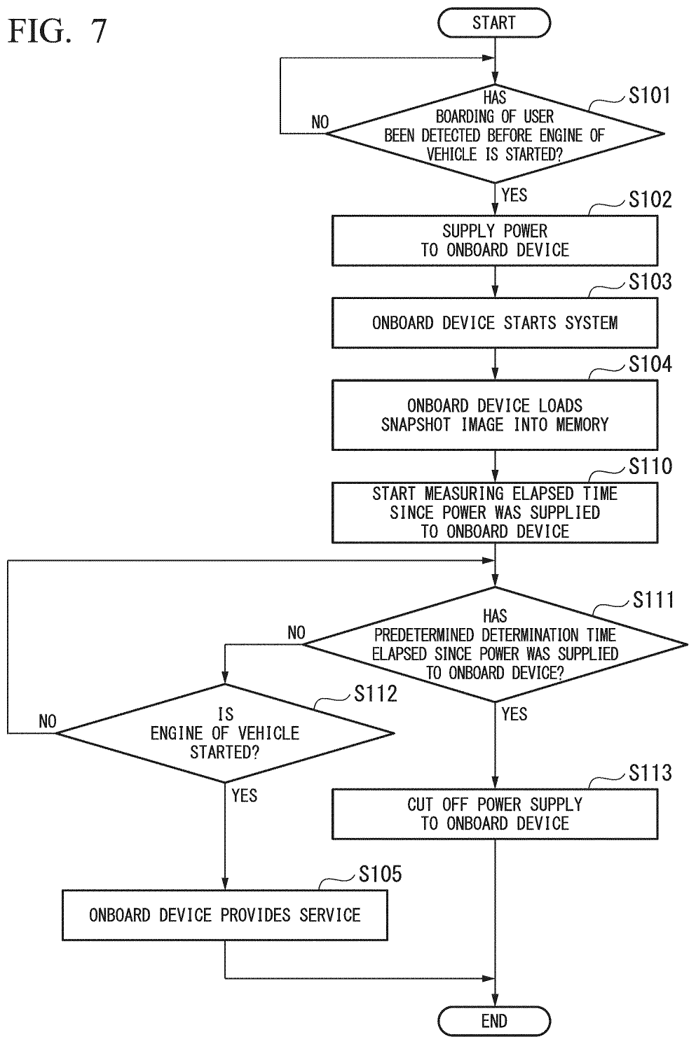

FIG. 6 is a block diagram illustrating a configuration of a power supply control device according to a second embodiment. FIG. 7 is a flowchart showing an operation of a power supply control device 10 according to the second embodiment. The power supply control device 10 according to the second embodiment will be described with reference to FIGS. 5 and 6. An onboard device 5, the power supply control device 10, and a vehicle 1 according to the second embodiment are configured and function similar to the onboard device 5, the power supply control device 10, and the vehicle 1 according to the first embodiment unless otherwise specified and thus redundant description is omitted.

### (Functional Configuration of Power Supply Control Device According to Second Embodiment)

As shown in FIG. 6, the power supply control device 10 according to the second embodiment includes a timer unit 13 configured to measure an elapsed time since the power supply control unit 12 supplied power to the onboard device 5. The power supply control device 10 according to the second embodiment differs from the power supply control device 10 according to the first embodiment in that it further includes the timer unit 13.

The timer unit 13 is configured to measure an elapsed time since the power supply control unit 12 supplied power to the onboard device 5. In the second embodiment of the present invention, the timer unit 13 may be configured to, for example, when the power supply control unit 12 has supplied power to the onboard device 5, be notified that power has been supplied to the onboard device 5. The timer unit 13 measures an elapsed time since it was notified that the power supply control unit 12 has supplied power to the onboard device 5.

The timer unit 13 may also be configured to end the elapsed time measuring process when an ignition signal indicating that the engine has been started is input to the power supply control device 10 from an ignition circuit (not shown).

Further, the timer unit 13 may be configured to, for example, when the elapsed time measured exceeds a predetermined determination time, notify the power supply control unit 12 of a signal indicating that the determination time has been exceeded. The power supply control unit 12 may determine that the predetermined determination time has elapsed since the power supply control unit 12 supplied power to the onboard device 5 on the basis of the notification from the timer unit 13 that the elapsed time has exceeded the predetermined determination time.

### (Processing Flow of Operation of Power Supply Control Device According to Second Embodiment)

FIG. 7 shows a series of processing in a single flowchart, similar to the first embodiment, where processing of steps S101 and S102 and S110 to S113 is performed by the power supply control device 10 and processing of steps S103 to S105 is performed by the onboard device 5. The power supply control device 10 proceeds to the processing of step S110 after the processing of step S102 in a flow of processing of the power supply control device 10 itself.

That is, the power supply control device 10 starts measuring an elapsed time through the timer unit 13 (step S110) after supplying power to the onboard device 5 in step S102.

Using the timer unit 13, the power supply control unit 12 determines whether or not a predetermined determination time has elapsed since power was supplied to the onboard device 5 (step S111).

If the predetermined determination time has not elapsed since power was supplied to the onboard device 5 (NO in step S111), the power supply control unit 12 monitors an ignition signal indicating that the engine has been started and determines whether or not the engine has been started (step S112).

If the engine of the vehicle 1 has not been started (NO in step S112), the power supply control unit 12 returns to the determination processing of step S111.

If the engine of the vehicle 1 is started before the predetermined determination time elapses since power was supplied to the onboard device 5 (YES in step S112), the power supply control unit 12 continues to supply power to the onboard device 5. Thereby, the onboard device 5 provides a service (step S105). The subsequent processing proceeds, similar to the first embodiment of the present invention described above with reference to FIG. 3.

On the other hand, if the predetermined determination time has elapsed without the engine of the vehicle 1 being started (YES in step S111), the power supply control unit 12 cuts off power supply to the onboard device 5 (step S113).

The predetermined determination time is a time predefined as a threshold for determining whether or not the user is actually about to drive the vehicle 1. If the engine of the vehicle 1 is not started within the predetermined determination time even though power supply to the onboard device 5 was started with detection of boarding of the user as a trigger, it can be determined that the user is not about to drive the vehicle 1 (although boarding of the user has been detected). For example, the case where the human detection sensor 3 has detected boarding but this detection is erroneous and the user has not actually boarded the vehicle 1 or the user has actually boarded the vehicle 1 but alighted without driving the vehicle can be considered.

In an example, an average of the actual time from when boarding of the vehicle 1 by the user is detected to when the user starts the engine is defined as the predetermined determination time.

### (Operations and Advantageous Effects)

In the power supply control device 10 according to the second embodiment, the power supply control unit 12 cuts off power supply from the battery mounted in the vehicle 1 to the onboard device if the engine of the vehicle 1 is not started within a predetermined determination time after power was supplied to the onboard device 5 as described above.

By doing so, it is possible to prevent a situation in which the power supply control device continues to supply power to the onboard device 5 even though the vehicle 1 is not immediately used for driving, for example, due to erroneous detection of the human detection sensor 3, and thus to limit waste of the battery 2 of the vehicle 1.

It has been described above that the power supply control unit 12 cuts off power supply to the onboard device 5 (step S113) when the predetermined determination time has elapsed without the engine of the vehicle 1 being started (i.e., upon timeout). In this case, even after the power supply control unit 12 cuts off power supply to the onboard device 5 through step S113, the power supply control unit 12 may further allow, for example, startup of the onboard device 5 shown in the startup procedure B in FIG. 4 to be performed if the engine is actually started after the power supply control unit 12 cuts off the power supply. By doing so, even if power is supplied to the onboard device 5 due to erroneous detection of the human detection sensor 3 or the like and then the power supply is cut off again due to subsequent timeout, power can be supplied to the onboard device 5 if the user starts the engine to drive the vehicle 1 after the power supply is cut off.

FIG. 8 is a schematic block diagram showing a configuration of a computer included in the power supply control device 10 according to at least one embodiment.

The computer 9 includes a CPU 91, a main storage device 92, an auxiliary storage device 93, and an interface 94.

The power supply control device 10 described above includes the computer 9. The operation of each processing part described above is stored in the auxiliary storage device 93 in the form of a program. The CPU 91 reads the program from the auxiliary storage device 93, loads the program into the main storage device 92, and executes the above processing according to the program. For example, the boarding detection signal receiver 11, the power supply control unit 12, and the timer unit 13 described above may be the CPU 91.

The CPU 91 secures a storage area corresponding to the database described above in the main storage device 92 or the auxiliary storage device 93 according to the program.

Examples of the auxiliary storage device 93 include a hard disk drive (HDD), a solid state drive (SSD), a magnetic disk, a magneto-optical disc, a compact disc read only memory (CD-ROM), and a digital versatile disc read only memory (DVD-ROM), and a semiconductor memory. The auxiliary storage device 93 may be an internal medium directly connected to a bus of the computer 9 or may be an external medium connected to the computer 9 via the interface 94 or a communication line. When the program is distributed to the computer 9 via a communication line, the computer 9 that has received the program may load the program into the main storage device 92 to execute the above processing. In at least one embodiment, the auxiliary storage device 93 is a non-transitory tangible storage medium.

The program may be one for realizing some of the above-described functions. The program may also be a so-called differential file (differential program) which realizes the functions described above in combination with another program already recorded in the auxiliary storage device 93.

Although some embodiments of the present invention have been described, these embodiments have been presented by way of example and are not intended to limit the scope of the invention. These embodiments can be implemented in various other forms, and various omissions, substitutions, and changes can be made without departing from the spirit of the invention. These embodiments and modifications thereof are included in the scope or spirit of the invention as well as in the scope of the invention described in the claims and their equivalents.

### INDUSTRIAL APPLICABILITY

The power supply control device, the vehicle including the power supply control device, the power supply control method, and the power supply control program described above effectively reduce the waiting time from when the engine is started in the vehicle in which the engine has been stopped to when the onboard device provides a service.

### REFERENCE SIGNS LIST

1 Vehicle
2 Battery
3 Human detection sensor
4 External memory
5 Onboard device
9 Computer
10 Power supply control device
11 Boarding detection signal receiver
12 Power supply control unit
13 Timer unit
91 CPU
92 Main memory
93 Auxiliary storage device
94 Interface
A Startup procedure of related art
A1 System startup process
A2 Application startup process
A3 Service providing process
B Startup procedure of related art
B1 System startup process
B2 Process of decompressing and loading snapshot image
B3 Service providing process
C Startup procedure of present invention
C1 System startup process
C2 Process of decompressing and loading snapshot image
C3 Service providing process
C4 Waiting process

1. A power supply control device for controlling power supply to an onboard device mounted in a vehicle, the power supply control device comprising:
a boarding detection signal receiver configured to receive a detection signal from a boarding detection unit configured to detect boarding of the vehicle by a user before an engine of the vehicle is started; and
a power supply control unit configured to supply power from a battery mounted in the vehicle to the onboard device upon receiving the detection signal.

2. The power supply control device according to claim 1, wherein the onboard device is configured to be started when power has been supplied from the battery mounted in the vehicle to the onboard device, and is configured not to provide a service to the user until the engine of the vehicle is started if it becomes possible to provide a service to the user before the engine of the vehicle is started.

3. The power supply control device according to claim 1, further comprising a timer unit configured to measure an elapsed time since power was supplied to the onboard device until the engine of the vehicle is started,
wherein the power supply control unit is configured to cut off power supply from the battery mounted in the vehicle to the onboard device if the engine of the vehicle is not started within a predetermined determination time after power was supplied to the onboard device.

4. A vehicle comprising:
the power supply control device according to claim 1;
the battery;
the onboard device; and
the boarding detection unit.

5. A power supply control method for controlling power supply to an onboard device mounted in a vehicle, the power supply control method comprising:
a boarding detection signal receiving step of receiving a detection signal from a boarding detection unit configured to detect boarding of the vehicle by a user before an engine of the vehicle is started; and
a power supply control step of supplying power from a battery mounted in the vehicle to the onboard device upon receiving the detection signal.

6. A non-transitory computer-readable medium that stores a power supply control program causing a computer serving as a power supply control device for controlling power supply to an onboard device mounted in a vehicle to function as:
a boarding detection signal receiver configured to receive a detection signal from a boarding detection unit configured to detect boarding of the vehicle by a user before an engine of the vehicle is started; and
a power supply control unit configured to supply power from a battery mounted in the vehicle to the onboard device upon receiving the detection signal.
